(19) United States
(12) Patent Application Publication
(10) Pub. No.: US 2010/0099441 A1
(43) Pub. Date: Apr. 22, 2010

(54) Mobile Device Advertising

(76) Inventors: Sanjay Agarwal, Sunnyvale, CA (US); Jennifer Liu Low, Sunnyvale, CA (US); Daniel T. Erat, San Francisco, CA (US); Jennifer W. Lin, Mountain View, CA (US); Sridhar Venkatakrishnan, Bangalore (IN)

Correspondence Address: FISH & RICHARDSON P.C., PO BOX 1022, MINNEAPOLIS, MN, 55440-1022, US

(21) Appl. No.: 12/253,640

(22) Filed: Oct. 17, 2008

(51) Int. Cl. H04W 4/00; G06Q 30/00; H04B 1/38

(52) U.S. Cl. 455/466; 705/10; 455/566; 705/14.64

(57) ABSTRACT

Methods and systems for mobile advertising that include receiving an advertisement banner from an advertiser, incorporating identifying information in to the advertisement banner to produce a modified advertisement banner, and displaying the modified advertisement banner on a display of a mobile device are disclosed.

### BACKGROUND

This disclosure relates to information management.

On-line advertisements (“ads”) allow advertisers to reach a wide range of viewers through the Internet. The selection of ads for presentation (e.g., display), such as with search results and other information, and the ordering of those advertisements, may be achieved by various techniques. In one example technique, an initial determination is made to identify all advertisements that are a match or near match for applied search terms or other query items or information. The match may be made, for example, between one or more words in a query, and keywords identified by an advertiser and associated with a particular advertisement or group of advertisements, such as a campaign.

The ads can be received by users of various devices, including desktop devices (e.g., desktop computers) and mobile devices (e.g., mobile phones). Because mobile devices often have smaller displays, the ads may be formatted differently depending on whether the ads are delivered to desktop or mobile devices.

### SUMMARY

In general, in one aspect, a method includes receiving an advertisement banner, incorporating identifying information into the advertisement banner to produce a modified advertisement banner, and providing the modified advertisement banner to a mobile device.

Implementations may include one or more of the following features. Incorporating identifying information to the advertisement banner can include generating the modified advertisement banner as a single image that includes the identifying information and the advertisement banner. The identifying information can include at least one of a company's uniform resource locator, the company's business name, the company's business phone number, and the company's logo. The uniform resource locator can link to a mobile landing page of the company. The identifying information can include at least one of information associated with an advertiser, information associated with a service provider that delivers the modified advertisement banner, and information associated with a communications service provider that delivers communications services to the mobile device.

The method can include automatically extracting the identifying information from metadata associated with the advertisement banner. The information associated with the advertiser can include an identifying mark of the advertiser. The method can include resizing the modified advertisement banner based on a parameter of the mobile device. The method can include determining whether the advertisement banner is larger than a predetermined size, and incorporating the identifying information into the advertisement banner when the advertisement banner is larger than the predetermined size.

The method can include selecting an advertisement banner to be placed on a mobile site based on one or more keywords associated with the advertisement banner. The method can include selecting an advertisement banner to be placed on a mobile site based on one or more keywords associated with the mobile site. The method can include selecting identifying information to be incorporated in to the advertisement banner based on predetermined criteria. The predetermined criteria includes at least one of a context of the advertisement banner, a context of the mobile page, and characteristics of a target audience.

The method can include, in response to a user action, automatically dialing a telephone number associated with the modified advertisement banner. The method can include, in response to a user action, automatically sending a short messaging service message to the mobile device, the message providing additional information associated with the modified advertisement banner. Incorporating identifying information into the advertisement banner to produce the modified advertisement banner can include generating the modified advertisement banner by appending the identifying information to the advertisement banner.

In another aspect, a method includes at a mobile device, receiving an advertisement banner transmitted through a network, incorporating identifying information in to the advertisement banner to produce a modified advertisement banner, and showing the modified advertisement banner on a display of the mobile device.

Implementations may include one or more of the following features. The method can include determining the identifying information based on metadata associated with the advertisement banner. The method can include, at the mobile device, receiving the identifying information transmitted through the network.

In another aspect, a mobile advertising system includes means for receiving an advertisement banner from an advertiser, means for incorporating identifying information in to the advertisement banner to produce a modified advertisement banner, and means for providing the modified advertisement banner to a display of a mobile device.

In another aspect, an apparatus includes a mobile advertisement server for receiving an advertisement banner and identifying information from an advertiser, generating a modified advertisement banner by incorporating the identifying information in to the advertisement banner, and providing the modified advertisement banner to a mobile device.

Implementations may include one or more of the following features. The mobile advertisement server is configured to generate the modified advertisement banner as a single image that includes the identifying information and the advertisement banner. The identifying information can include at least one of a company's uniform resource locator, a company's business name, a company's business phone number, and a company's logo. The uniform resource locator can link to a mobile landing page of the advertiser.

The identifying information can include at least one of information associated with the advertiser, information associated with a service provider that delivers the modified advertisement banner, and information associated with a communications service provider that delivers communications services to the mobile device. The mobile advertisement server is configured to automatically extract the identifying information from metadata associated with the advertisement banner.

The information associated with the advertiser can include an identifying mark of the advertiser. The mobile advertisement server is configured to resize the modified advertisement banner based on a parameter of the mobile device. The mobile advertisement server is configured to determine whether the advertisement banner is larger than a predetermined size, and incorporate the identifying information into the advertisement banner when the advertisement banner is larger than the predetermined size. The mobile advertisement server is configured to select an advertisement banner to be placed on a mobile site based on one or more keywords associated with the advertisement banner.

The mobile advertisement server is configured to select an advertisement banner to be placed on a mobile site based on one or more keywords associated with the mobile site. The mobile advertisement server is configured to select identifying information to be incorporated in to the advertisement banner based on predetermined criteria. The predetermined criteria can include at least one of a context of the advertisement banner, a context of the mobile page, and characteristics of a target audience. The mobile advertisement server is configured to generate the modified advertisement banner by appending the identifying information to the advertisement banner.

Other aspects include other combinations of the features recited above and other features, expressed as methods, apparatus, systems, computer-readable media, program products, and in other ways. Other features and advantages will be apparent from the description and from the claims.

### DRAWINGS

FIG. 1 is a diagram of an example mobile device advertising system.

FIGS. 2A-C are exemplary layouts of modified ad banners.

FIG. 3 shows example modified ad banners.

FIG. 4 is a flowchart of an example stitching process.

FIG. 5 is an example screenshot.

### DESCRIPTION

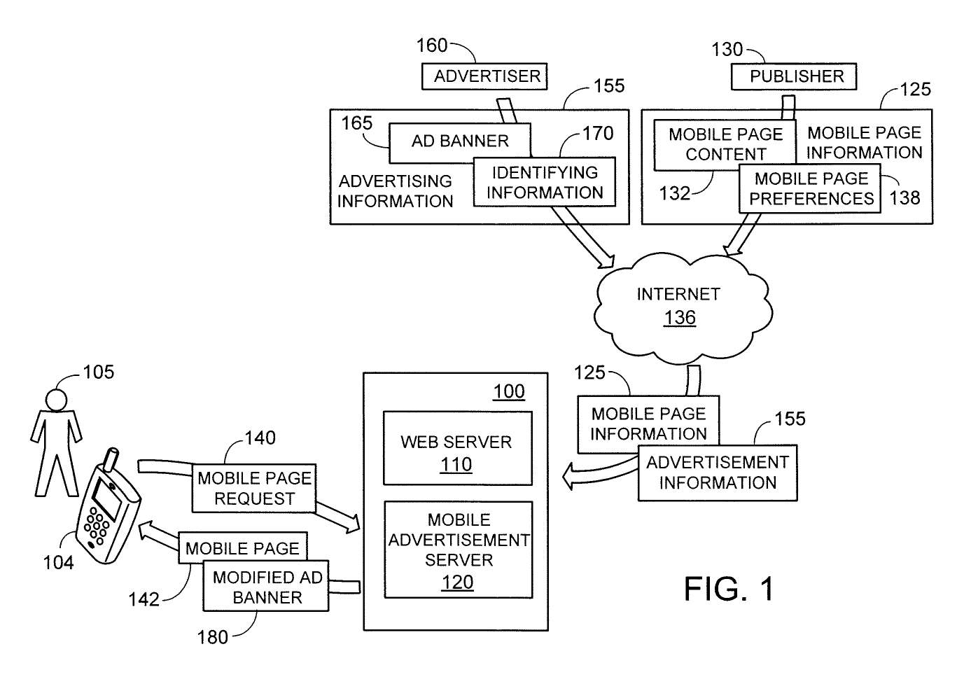

Referring to FIG. 1, an example advertising system 100 delivers ads to various devices, including mobile devices 104, such as mobile phones or personal digital assistants, of users 105. The ad banner 165 may include, e.g., text, images, banners, or combinations of the above. In the examples described below, the ad banners 165 are mobile ad banners that are formatted to be suitable for display on the mobile devices 104. It is understood that the ad banners 165 can also be formatted for display on other devices. Each ad banner 165 can be, e.g., an image that shows alphanumeric symbols, graphical elements, or a combination of both. An advantage of mobile ad banners 165 is that they are displayed prominently on the mobile device 104 screen and may have a high click-through rate (CTR).

The system 100 generally includes a web server 110 and a mobile advertisement server 120. The system 100 is set up using a typical server-client model. Accordingly, publishers 130 can connect to the web server 110 to upload mobile page information 125, e.g., mobile page content 132 and mobile page preferences 138 through a web design interface installed on the publishers' 130 terminal. The web server 110 responds to mobile page requests 140 from mobile devices 104 by transmitting the requested mobile pages 142 along with ad banners, e.g., modified ad banners 180. The mobile page preferences 138 can include, e.g., restrictions on size, content and placement of the ad banners on the mobile page 142.

Advertisers 160 can connect to the mobile advertisement server 120 to upload advertisement information 155 through a user interface at the advertisers' 160 terminal. The advertisement information 155 for an advertiser 160 typically includes an ad banner 165 and identifying information 170 associated with the ad banner 165 and the advertiser 160.

A feature of the advertising system 100 is that the identifying information 170 is “stitched” into a mobile ad banner 165 to generate a modified mobile ad banner 180. In some examples, the stitching of the identifying information 170 includes generating a single image corresponding to the modified ad banner 180 by incorporating the identifying information 170 in the original ad banner 165. In some examples, the stitching of the identifying information 170 includes appending the identifying information 170 to the original ad banner 165.

In some examples, the stitching of the identifying information 170 to an ad banner 165 can occur, e.g., just prior to a mobile ad server 120 delivering a mobile page 142 with a modified ad banner 180 to a mobile device 104, or when the mobile device 104 displays the mobile page 142 and the modified ad banner 180 to the user 105. This provides flexibility in customizing the modified ad banners 180 to show various identifying information 170.

The identifying information 170 can include an identifying mark (e.g., “Ads by Provider”) of a service provider that delivers the modified ad banner 180. When advertisers 160 design ad banners 165, they may not know beforehand which service provider will deliver the modified ad banners 180 to the user 105. A modified ad banner 180 may be delivered by various service providers. Rather than designing multiple modified ad banners 180 having different identifying marks, it is more convenient to allow the identifying mark to be stitched into the original ad banner 165 at the time a mobile page 142 along with the modified ad banner 180 is delivered to the user 105, or when the modified ad banner 180 is displayed by the mobile device 104 to the user 105.

Typically, a service provider that delivers mobile ad banners 165 to mobile devices 104 is different from a communications service provider that provides voice and data capabilities to the mobile devices 104. Accordingly, the identifying information 170 may include identifying marks for both the service provider that delivers the mobile ad banner 165 to mobile devices 104 and the communications service provider.

The identifying marks may be in the form of a logo, trademark, or any other special symbol associated with either the service provider that delivers mobile ad banners 165 or the communications service provider. For example, the identifying information 170 stitched in to the ad banner 165 may include the communications service provider's identifying mark “Brought to you by Verizon” in addition to an identifying mark of the service provider that delivers the modified ad banner 180.

In some implementations, the identifying information 170 can include an identifying mark of the advertiser 160 in addition to the identifying mark of the service provider that delivers the modified ad banner 180. For example, the mobile advertiser server 120 can be configured to automatically stitch the advertiser's 160 business name in to the ad banner 165.

The advertiser 160 can select from a variety of available formats, content and styles of identifying information 170 to stitch in to the ad banner 165. In addition, the advertisers 160 can specify that identifying information 170 containing an identifying mark of the advertiser 160 is to not be stitched in to the ad banner 165.

The identifying information 170 can include a universal resource locator (URL), a company name, and a telephone number of the advertiser 165. For example, an advertiser 165 such as General Motors can upload a mobile ad banner 165 that says “Drive the New Buick Aperture!” The identifying information 170 incorporated in to the ad banner 165 may include the General Motors' website address “www.gm.com.” A mobile user 105 viewing the ad banner 165 on the mobile device 104 can also opt to visit General Motor's website by clicking on the URL.

Each advertiser 160 can be associated with a mobile landing page that is a web page optimized for viewing on the mobile device 104. Accordingly, the identifying information 170 can include a URL to the mobile landing page. In some implementations, the mobile landing page can include, e.g., text describing the company's products or services, a business phone number, and a company's logo. The mobile landing page can also provide links to other web pages that are optimized for viewing on the mobile device 104.

The advertiser 160 can specify additional information for customizing ad banners 165, such as parameters (e.g., screen size) of the target mobile device 104 where the ad banner 165 is delivered. For example, if the mobile device 104 has a larger screen and the ad banner can be displayed in a larger size, more identifying information 170 can be stitched to the ad banner 165. If the mobile device 104 has a smaller screen and the ad banner 165 has to be displayed in a smaller size, then only a portion of the identifying information 170 is stitched into the ad banner 165.

In some implementations, if the ad banner 165 has sufficient space, the URL, company name, and telephone number are all stitched into the ad banner 165. If there is only a small amount of space, then only one of the identifying information, e.g., the URL, is stitched into the ad banner 165.

In some implementations, the mobile ad banners 165 are image files, such as GIF or JPEG images. The identifying information 170 is also provided as image files, such as GIF or JPEG images. In some examples, the identifying information 170 is provided as text or graphic elements. The advertising system 100 is configured so that when identifying information 170 is stitched into the ad banners 165 provided by the advertisers 165, useful information (e.g., product or service descriptions) originally included in the ad banner 165 is not removed or altered. This can be achieved by, e.g., pre-allocating a space or region in the ad banner 165 to allow the identifying information 170 to be added to the ad banner 165.

Stitching an image having identifying information 170 to an image of an ad banner 165 having a product description is different from merely concatenating a text string of identifying information 170 to a text string of product description. In some examples, stitching an image having identifying information 170 to an image of an ad banner 165 having a product description includes combining two image files and generating a modified ad banner 180 as a single image file that incorporates the identifying information 170. In this manner, the identifying information 170 no longer is a separate image, but is integrated into the modified ad banner 180.

In some examples, if the identifying information 170 is a text string and the ad banner 165 is an image, the identifying information 170 may first be converted into an image displaying the text using any technique known in the art, and then the image may be stitched in to the ad banner 165.

The identifying information 170 can provide functions in addition to identifying the service provider. For example, the identifying information 170 provided by the advertisers 160 is used to categorize the ad banners 165 based on keywords (e.g., “vehicle,” “pizza”) appearing in the identifying information 170. In some implementations, the ad banners 165 are categorized based on metadata contained in the original ad banners 165 (i.e., before the identifying information 170 is stitched into the ad banner 165). The ad banners 165 can also be categorized based on information acquired from the advertiser's 160 account with the service provider. For example, an ad banner 165 by General Motors may be categorized as a vehicle advertisement by drawing on information in General Motors' account with the service provider.

The advertisers 160 can also provide additional information regarding the advertisers' 160 products or services. This additional information can be used by the mobile ad server 170 to determine the mobile pages 142 on which to place the modified ad banners 180. For example, the advertisers 160 can specify that an ad banner 165 is targeted at a specific group of users 105 based on predetermined characteristics of the group, e.g., user profile information, such as, age and gender.

Modified ad banners 180 are placed on mobile pages 142 based on mobile page preferences 138 provided by the publishers 130. In some examples, the mobile page preferences 138 can be used to specify preferences for content, format, or type of ad banners 180 to be placed on a mobile page 142. For example, a vehicle enthusiast who uploads mobile page content 132 for a vehicle enthusiasts community can specify that the content of the modified ad banners 180 placed on his page be restricted to cars or trucks ads. In some examples, the mobile page preferences 138 may also include restrictions on dimensions of the modified ad banner 180.

Keywords can be identified from the mobile page content 132 to categorize the mobile pages. For example, the vehicle enthusiasts community's mobile page can be categorized based on the use of words such as “Buick,” or “truck,” in the mobile page content 132. Accordingly, a modified ad banner 180 for a General Motors truck may be selected to be placed on the vehicle enthusiast's mobile webpage.

In some implementations, the publishers 130 may provide keywords, or brief descriptions about the nature and content of their mobile pages 142. The modified ad banner 180 to be placed on these mobile pages 142 can be selected based on the keywords or descriptions. In some examples, the mobile ad banners 180 can also be selected based on characteristics of the audience of the mobile webpage.

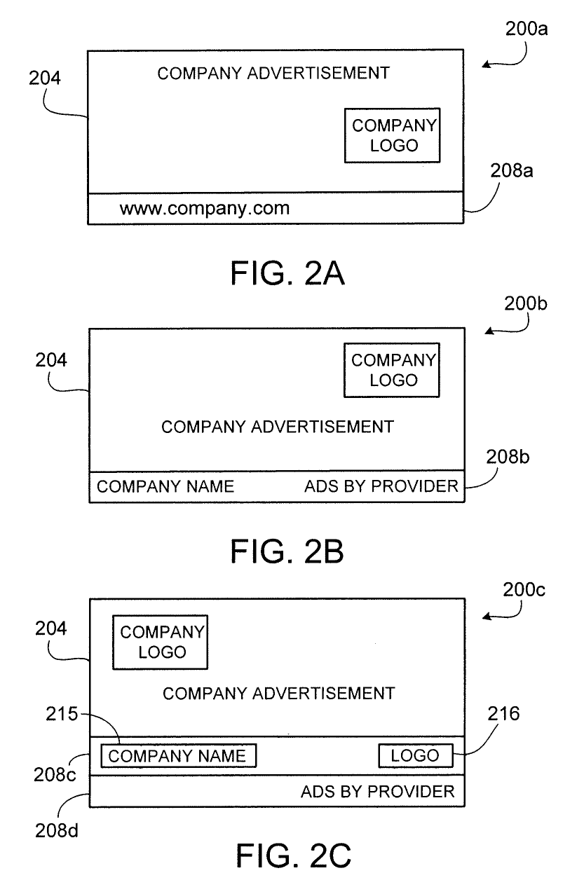

Referring to FIGS. 2A-C, in some implementations, modified ad banners 200a-c, collectively referred to as 200, each include an ad banner portion 204 and an identifying information portion 208a, 208b or 208c, collectively referred to as 208. The modified ad banners 200a-c can have various configurations. Also, the identifying information portions 208a-c can include a variety of identifying information.

In general, the original ad banner 165 uploaded to the mobile ad server 170 by the advertiser 165 forms the ad banner portion 204. In some examples, stitching the identifying information portion 208 to the ad banner portion 204 includes generating a new ad banner as the modified ad banner 200 that incorporates the identifying information portion 208 in the original ad banner 165. As described above, stitching the identifying information portion 208 to the ad banner portion 208 can also include appending the identifying information portion 208 to the ad banner portion 208.

In some implementations, the mobile device 104 may receive the identifying information portion 208 and the ad banner portion 204 in separate transmissions from the mobile ad server 120. Accordingly, the identifying information portion 208 can be stitched to the ad banner portion 204 at the mobile device 104. In some implementations, the stitching of the identifying information portion 208 to the ad banner portion 204 is performed dynamically, i.e., substantially simultaneously with displaying the modified ad banner 200 on the mobile device 104. In some implementations, the stitching of the identifying information portion 208 to the ad banner portion 204 is performed prior to displaying the modified ad banner 200 on the mobile device 104.

The identifying information portion 208 can include, for example, the business name of a company, a URL to the company's mobile landing page, or a business phone number. In some examples, the identifying information portion 208 can also include a company logo (e.g., logo 216 in FIG. 2C). Referring to FIG. 2B, an identifying information portion 208b can include an identifying mark of the service provider, e.g., “Ads by Provider,” in addition to the identifying information for the company.

In some examples multiple identifying information portions 208 can be stitched to the ad banner portion. For example, as shown in FIG. 2C, in addition to a first identifying information portion 208c displaying a company name 215 and company logo 216, a second identifying portion 208d displaying the identifying mark of the service provider can be stitched to the modified ad banner 200c.

The type of identifying information portion 208 that is stitched to the ad banner portion 204 can be specified by the advertiser 160. For example, the advertiser 160 may specify that the identifying information portion 208 include a company URL, company name 215, and a company logo 216.

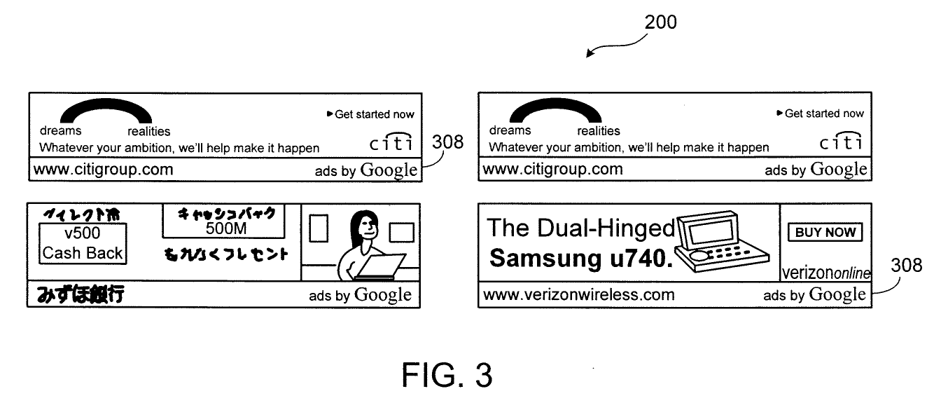

Examples of modified ad banners 200 are shown in FIG. 3. As shown, the identifying information portion 308 includes a company URL, e.g., www.citigroup.com or www.verizonwireless.com, and an identifying mark of the service provider, e.g., “Ads by Google.”

Although the identifying information portions 208a-c are shown in FIG. 3 (and FIGS. 2A-C) as being located below the ad banner portion 204, the identifying information portions 208a-c can be located anywhere on the modified ad banner 200. Accordingly, the identifying information portions 208a-c can be stitched so that they are located along any one of a left, right, or top boundary of the ad banner portion 204. In some examples, the identifying information portions 208a-c do not extend along the entire boundary, but extend over only a fraction of the boundary. In some examples, the identifying information portions 208a-c is located within the ad banner portion 204 of the modified ad banner 200.

The ad banner portion 204 can be a text-based or image-based. The images used in the ad banner portion 204 can be flash or static images. In some implementations, the images can have text, color and any other features conventionally available in advertisement images. Other capabilities normally available in an image on a regular webpage can also be included in the images used in the ad banner portion 204.

In some examples, the modified ad banner 200 can be in the form of a pop-up banner, i.e., a mini mobile webpage that contains content similar to a regular mobile webpage, and which can be displayed on top of a current mobile webpage.

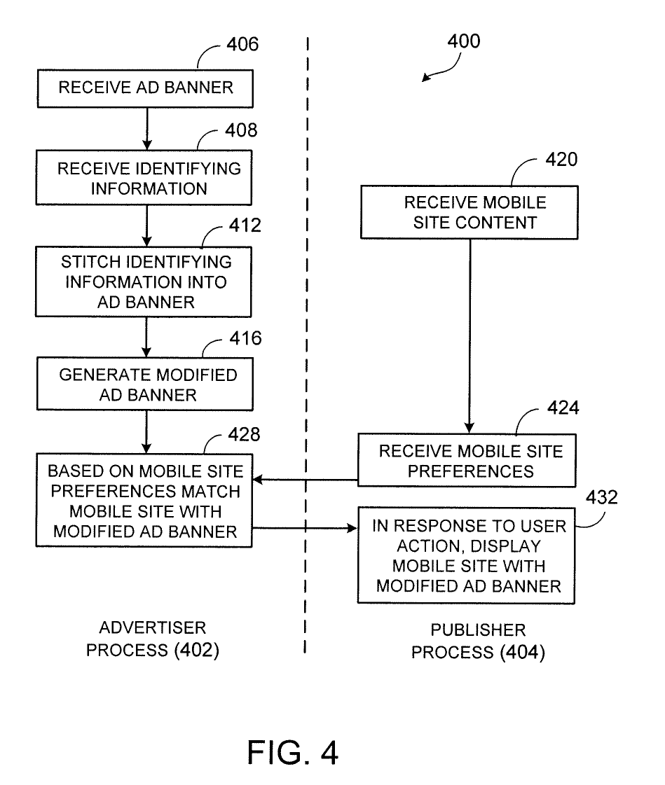

Referring now to FIG. 4, a flow diagram of an example process 400 for stitching identifying information 170 to an ad banner 165 is shown. As described above, a publisher 130 may connect to a server that is different from the mobile ad server 120 (e.g., web server 110). Accordingly, the process 400 can be cast as two independent processes 402, 404, running simultaneously on separate servers (e.g., the web server 110 and the mobile ad server 120). An advertiser process 402 corresponds to a series of steps or events involving the advertiser 160 and the ad banner 165. A publisher process 404 corresponds to a series of steps or events involving the publisher 130 and the publisher's mobile page 142.

An original ad banner 165 (a text or image banner), is received from an advertiser 160. (Step 406) Identifying information 170 is also received from the advertiser 160. (Step 408) In some examples, the identifying information 170 can be generated automatically from the metadata contained in the ad banner 165. For example, a company name or URL can be automatically extracted from metadata associated with an image-based ad banner 165 using any technique known to those skilled in the art.

The identifying information 170 can also accessed from a separate database (not shown) storing predetermined characteristics about the ad banner 165 based on historical information regarding the advertiser 160. For example, a regular advertiser 160 may have a new ad banner 165 which is only slightly different from an earlier ad banner 165. Rather than having the advertiser 160 re-enter the identifying information 170 once again, the mobile ad server 120 may connect to the database to retrieve the old identifying information 170. The advertiser 160 may then review the information, and make any changes before accepting the information as the new identifying information 170.

The identifying information 170 is then stitched into the ad banner 165. (Step 412) As described above, the identifying information 170 that is presented to a mobile device 104 may include, e.g., a company name and logo, or only a company name. The advertiser 160 may specify a manner in which identifying information 170 is presented to the mobile device 104. In some examples, the service provider specifies a standard form of presenting the modified ad banner 180 to the mobile device 104.

A modified ad banner 180 is generated based on the identifying information 170 and the original ad banner 165. (Step 416) As described above, a variety of configurations for the modified ad banner 180 is possible. The advertiser 160 may specify which configuration is desirable, or in some examples, the service provider specifies a standard configuration for the modified ad banner 180.

In the publisher process 404, mobile page content 132 is received from a publisher 130. (Step 420) The publisher 130 also specifies mobile page preferences 138. (Step 424) In some examples, the mobile page content 132 and mobile page preferences 138 are stored in the mobile ad server 120.

The mobile ad server 120 then matches the modified ad banner 180 with the mobile page based on the mobile page preferences 138. (Step 428) In response, to a user 105 action, e.g., a request from a user 105 for a mobile page 142, the mobile page 142 and the modified ad banner 180 are shown on the display of the mobile device 104, or delivered to the mobile device 105. (Step 432).

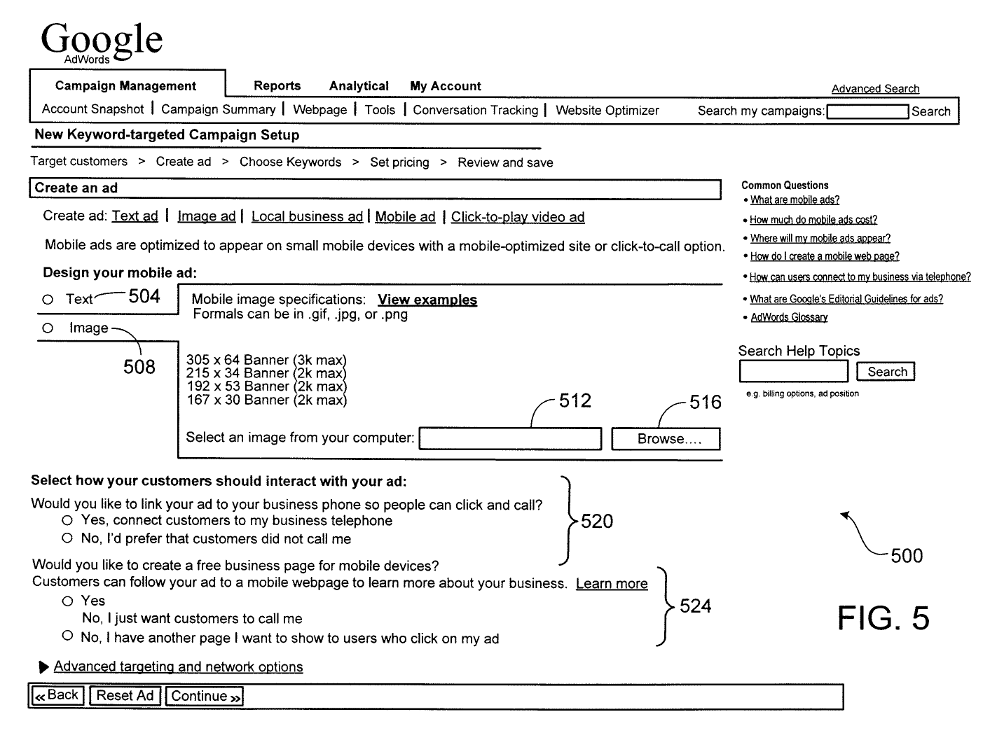

FIG. 5 is an example screenshot 500 from the mobile device advertising system 100, showing exemplary features of an advertiser setup panel. As described above, in some implementations, the advertiser setup panel is configured to run on a client terminal (not shown) and log in to the mobile advertisement server 120.

As shown, an advertiser 160 is invited to upload either a text based 504 or an image based 508 ad banner 165 from a local hard drive in the text field 512. The “Browse . . . ” button is then activated to populate the text field 512 with a directory path to the image's location on the local hard drive. The advertiser's 160 identifying information 170 is already pre-stored based on the advertiser's account information.

The advertiser 165 is then presented with options such as “click and call” 520, and “create a business page” 524. In the “click and call” 520 option, the advertiser 160 is invited to set up a business telephone number that is automatically dialed when a user 105 of the mobile device 104 clicks on a modified ad banner 180. In the “create a business page” 524 option, the advertiser is invited to create a mobile landing page. As described above, the URL of the mobile landing page may then be included with the identifying information 170 for displaying on a modified ad banner 180.

In some examples, combinations of the above ways of receiving identifying information are used. Various implementations of the mobile device advertising system 100 can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including but not limited to at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including but not limited to a machine-readable medium that receives machine instructions as a machine-readable signal. The term “machine-readable signal” refers to any signal used to provide machine instructions and/or data to a programmable processor.

To provide for interaction with a user 105, the mobile advertising system 10 can be implemented on a computer having a display device (e.g., a CRT (cathode ray tube) or LCD (liquid crystal display) monitor) for displaying information to the user 105 and a keyboard and a pointing device (e.g., a mouse or a trackball) by which the user 105 can provide input to the computer. Other kinds of devices can be used to provide for interaction with a user 105 as well; for example, feedback provided to the user 105 can be any form of sensory feedback (e.g., visual feedback, auditory feedback, or tactile feedback); and input from the user 105 can be received in any form, including but not limited to acoustic, speech, or tactile input.

The mobile advertising system 100 can be implemented in a computing system that includes a back end component (e.g., as a data server), or that includes a middleware component (e.g., an application server), or that includes a front end component (e.g., a client computer having a graphical user interface or a Web browser through which a user 105 can interact with an implementation of the mobile device advertising system 100), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other embodiments are within the scope of the following claims.

What is claimed is:

1. A method comprising:
receiving an advertisement banner,
incorporating identifying information into the advertisement banner to produce a modified advertisement banner, and
providing the modified advertisement banner to a mobile device.

2. The method of claim 1, in which incorporating identifying information to the advertisement banner comprises generating the modified advertisement banner as a single image that includes the identifying information and the advertisement banner.

3. The method of claim 1, in which the identifying information comprises at least one of a company's uniform resource locator, the company's business name, the company's business phone number, and the company's logo.

4. The method of claim 1, in which the identifying information comprises at least one of information associated with an advertiser, information associated with a service provider that delivers the modified advertisement banner, and information associated with a communications service provider that delivers communications services to the mobile device.

5. The method of claim 1, further comprising automatically extracting the identifying information from metadata associated with the advertisement banner.

6. The method of claim 3, in which the uniform resource locator links to a mobile landing page of the company.

7. The method of claim 4, in which the information associated with the advertiser includes an identifying mark of the advertiser.

8. The method of claim 1, further comprising resizing the modified advertisement banner based on a parameter of the mobile device.

9. The method of claim 1, further comprising determining whether the advertisement banner is larger than a predetermined size, and incorporating the identifying information into the advertisement banner when the advertisement banner is larger than the predetermined size.

10. The method of claim 1, further comprising selecting an advertisement banner to be placed on a mobile site based on one or more keywords associated with the advertisement banner.

11. The method of claim 1, further comprising selecting an advertisement banner to be placed on a mobile site based on one or more keywords associated with the mobile site.

12. The method of claim 1, further comprising selecting identifying information to be incorporated in to the advertisement banner based on predetermined criteria.

13. The method of claim 12, in which the predetermined criteria includes at least one of a context of the advertisement banner, a context of the mobile page, and characteristics of a target audience.

14. The method of claim 1, further comprising, in response to a user action, automatically dialing a telephone number associated with the modified advertisement banner.

15. The method of claim 1, further comprising, in response to a user action, automatically sending a short messaging service message to the mobile device, the message providing additional information associated with the modified advertisement banner.

16. The method of claim 1, in which incorporating identifying information into the advertisement banner to produce the modified advertisement banner includes generating the modified advertisement banner by appending the identifying information to the advertisement banner.

17. A method comprising:
at a mobile device,
receiving an advertisement banner transmitted through a network,
incorporating identifying information in to the advertisement banner to produce a modified advertisement banner, and
showing the modified advertisement banner on a display of the mobile device.

18. The method of claim 15, further comprising determining the identifying information based on metadata associated with the advertisement banner.

19. The method of claim 15, further comprising, at the mobile device, receiving the identifying information transmitted through the network.

20. A mobile advertising system comprising:
a means for receiving an advertisement banner from an advertiser,
a means for incorporating identifying information in to the advertisement banner to produce a modified advertisement banner, and
a means for providing the modified advertisement banner to a display of a mobile device.

21. An apparatus comprising:
a mobile advertisement server for:
receiving an advertisement banner and identifying information from an advertiser,
generating a modified advertisement banner by incorporating the identifying information in to the advertisement banner, and
providing the modified advertisement banner to a mobile device.

22. The apparatus of claim 21, in which the mobile advertisement server is configured to generate the modified advertisement banner as a single image that includes the identifying information and the advertisement banner.

23. The apparatus of claim 21, in which the identifying information comprises at least one of a company's uniform resource locator, a company's business name, a company's business phone number, and a company's logo.

24. The apparatus of claim 21, in which the identifying information comprises at least one of information associated with the advertiser, information associated with a service provider that delivers the modified advertisement banner, and information associated with a communications service provider that delivers communications services to the mobile device.

25. The apparatus of claim 21, in which the mobile advertisement server is configured to automatically extract the identifying information from metadata associated with the advertisement banner.

26. The apparatus of claim 23, in which the uniform resource locator links to a mobile landing page of the advertiser.

27. The apparatus of claim 24, in which the information associated with the advertiser includes an identifying mark of the advertiser.

28. The apparatus of claim 21, in which the mobile advertisement server is configured to resize the modified advertisement banner based on a parameter of the mobile device.

29. The apparatus of claim 21, in which the mobile advertisement server is configured to determine whether the advertisement banner is larger than a predetermined size, and incorporate the identifying information into the advertisement banner when the advertisement banner is larger than the predetermined size.

30. The apparatus of claim 21, in which the mobile advertisement server is configured to select an advertisement banner to be placed on a mobile site based on one or more keywords associated with the advertisement banner.

31. The apparatus of claim 21, in which the mobile advertisement server is configured to select an advertisement banner to be placed on a mobile site based on one or more keywords associated with the mobile site.

32. The apparatus of claim 21, in which the mobile advertisement server is configured to select identifying information to be incorporated in to the advertisement banner based on predetermined criteria.

33. The apparatus of claim 32, in which the predetermined criteria includes at least one of a context of the advertisement banner, a context of the mobile page, and characteristics of a target audience.

34. The apparatus of claim 21, in which the mobile advertisement server is configured to generate the modified advertisement banner by appending the identifying information to the advertisement banner.
